(19) United States
(12) Patent Application Publication
(10) Pub. No.: US 2013/0204988 A1
(43) Pub. Date: Aug. 8, 2013

(54) METHOD AND SYSTEM FOR LOOPBACK PROXY

(71) Applicants: Avininder Pal Singh Grewal, (US); Eric Eden, Vancouver (CA)

(72) Inventors: Avininder Pal Singh Grewal, (US); Eric Eden, Vancouver (CA)

(73) Assignee: Mobidia Technology, Inc., Richmond (CA)

(21) Appl. No.: 13/565,457

(22) Filed: Aug. 2, 2012

Related U.S. Application Data
(63) Continuation-in-part of application No. 13/559,305, filed on Jul. 26, 2012, now abandoned.
(60) Provisional application No. 61/512,297, filed on Jul. 27, 2011.

(51) Int. Cl. H04L 29/06

(52) U.S. Cl. CPC H04L 65/105
USPC 709/221; 709/223

(57) ABSTRACT

A method for managing TCP sessions with a mobile device. A loopback proxy is configured within the mobile device to re-direct HTTP requests by the mobile device to a remote server back to the mobile device. The proxy accepts the local TCP connection initiated by the mobile device, extracts address and port information for the remote server from the HTTP request, then communicates with the remote server on behalf of the mobile device in order to open a remote TCP connection. The proxy then fuses the streams of the local TCP connection with those of the remote TCP connection.

### CLAIM OF PRIORITY

This application is a continuation-in-part of U.S. application Ser. No. 13/559,305 entitled Methods and Systems for Loopback Proxy, filed Jul. 26, 2012, which claims the benefit of U.S. Provisional Patent App. No. 61/512,297 entitled Methods and Systems for Loopback Proxy, filed Jul. 27, 2011, and the entire contents of both applications are incorporated herein by reference.

### TECHNICAL FIELD

This disclosure relates generally to the field of packet-based networks, and more specifically, to systems and methods for managing TCP sessions in a mobile device.

### BACKGROUND

This disclosure relates generally to the field of packet-based networks, and more specifically, to systems and methods for managing TCP sessions in a mobile device.

A significant number of packet protocols have been developed and optimized specifically for wired networks. For example, the Transmission Control Protocol (“TCP”) has been adapted over time with congestion control to achieve maximum throughput in fixed bandwidth networks, and to work in a “fair” manner even during heavy network congestion. However, with the move to packet-based networks over a wireless infrastructure, these congestion mechanisms are not always well-suited to the different characteristics found in such a wireless domain, such as:

1. A longer latency/round trip time. The lower bandwidth of the wireless network introduces a considerable amount of latency for a packet. The longer latency is also caused by the nature of the shared network, in which each session waits for the appropriate scheduling to enter the network.

2. Variable bandwidth. The bandwidth available to a given mobile or wireless device is a function of many factors. For example, as the user moves, the distance to the antennae moves, which may result in obstructions. Even if the user is stationary there are factors that can impact bandwidth, including vehicles moving between the user and the antennae, other users on the network entering and leaving the shared medium, proximity to other networks, and the associated power/bandwidth management of the radio frequency (“RF”) signals.

3. Asymmetrical bandwidth. Downstream bandwidth from the network to the user equipment (“UE”) is typically higher than upstream bandwidth from the UE to the network. When downloading data, the speed of the download is governed by the speed of the returning acknowledgment (“ACK”) on the upstream. If the upstream is congested, then the download bandwidth may not be fully consumed to its full potential.

The longer latency and longer round trip time (“RTT”) impacts TCP's ability to quickly ascertain the available bandwidth in a static bandwidth environment. In an environment with a high variable bandwidth, the problem is exacerbated for TCP to efficiently track the available bandwidth.

Variable bandwidth can also indirectly lead to packet drop, which is a significant concern for a wireless network operator. In a situation in which two or more TCP sessions are made aware of available bandwidth in the wireless network, they will increase their data flow speed. This can result in an overloading of the buffers inside the network. Consequently, packets can be dropped off of the tail of the buffer. When there is an excess of packets and some are dropped, retransmission occurs, consuming resources that would otherwise be used to transport new packets.

Further, there are often multiple, simultaneous TCP sessions from multiple sources all destined for a single endpoint. An example would be a user surfing the Internet (which contains multiple sessions in itself) on a mobile device, while downloading an email. With multiple sessions, all independent of each other, the difficulty in ascertaining the available bandwidth across all the sessions is increased. This traffic can be characterized as “bursty” since in the aggregate of all sessions, the instantaneous bandwidth can far exceed or be well below the overall capacity of the wireless network.

The TCP protocol is ubiquitous and has to serve all types of network topologies, including wireless. It is thus highly desirable that any improvements in efficiency must be invisible and applicable to the existing servers that are the source of the TCP sessions, and the clients that are the recipients of the TCP sessions. It is also a requirement that any improvement have no effect on other network traffic and that full Quality of Service (QoS) be maintained.

### BRIEF SUMMARY

This disclosure relates to a method for managing TCP sessions with a mobile device. A loopback proxy in the mobile device modifies APN settings to point back to the localhost with a fixed port. Thus, HTTP requests from the mobile device to a remote host are intercepted by the proxy. The proxy identifies the source port as well as the destination address and destination port for the remote host, then fuses the local and remote TCP connection streams so that all incoming data from the remote connection is sent to the local stream and all incoming data from the local connection is sent to the remote stream.

### BRIEF DESCRIPTION OF THE DRAWINGS

FIG. 1 is a block diagram illustrating the architecture and TCP data flow of a system having a mobile device;

FIG. 2 is a flow diagram showing one embodiment of a process for managing TCP sessions at a mobile device; and

FIG. 3 is a timing diagram illustrating connection and termination of a TCP session.

### DETAILED DESCRIPTION

The following detailed disclosure is directed to a method for managing TCP sessions with a mobile device. A loopback proxy is configured within the mobile device to modify APN settings of the mobile device to point to the localhost with a fixed port. HTTP requests from the mobile device to a remote host are thus received back at the mobile device, where the loopback proxy handles managing the TCP connection process. The proxy identifies the source port that an application on the mobile device used to connect to the proxy. Further, the proxy extracts the destination address and destination port for the remote host from the URL provided by the mobile device. The local and remote TCP connection streams are then fused by the proxy so that all incoming data from the remote connection is sent to the local stream and all incoming data from the local connection is sent to the remote stream.

It should be appreciated that embodiments can be implemented in numerous ways, including as a process, an apparatus, a system, a device, a method, a computer readable medium such as a non-transitory computer readable storage medium containing computer readable instructions or computer program code, or as a computer program product comprising a computer usable medium having a computer readable program code embodied therein.

In the context of this document, a computer usable medium or computer readable medium may be any non-transitory medium that can contain or store program instructions for use by or in connection with an instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing an embodiment. Applications may also be downloaded in whole or in part through the use of a software development kit or toolkit that enables the creation and implementation of an embodiment. In this specification, these implementations, or any other form that an embodiment may take, may be referred to as techniques. In general, the order of the steps of disclosed processes may be altered within the scope of this disclosure.

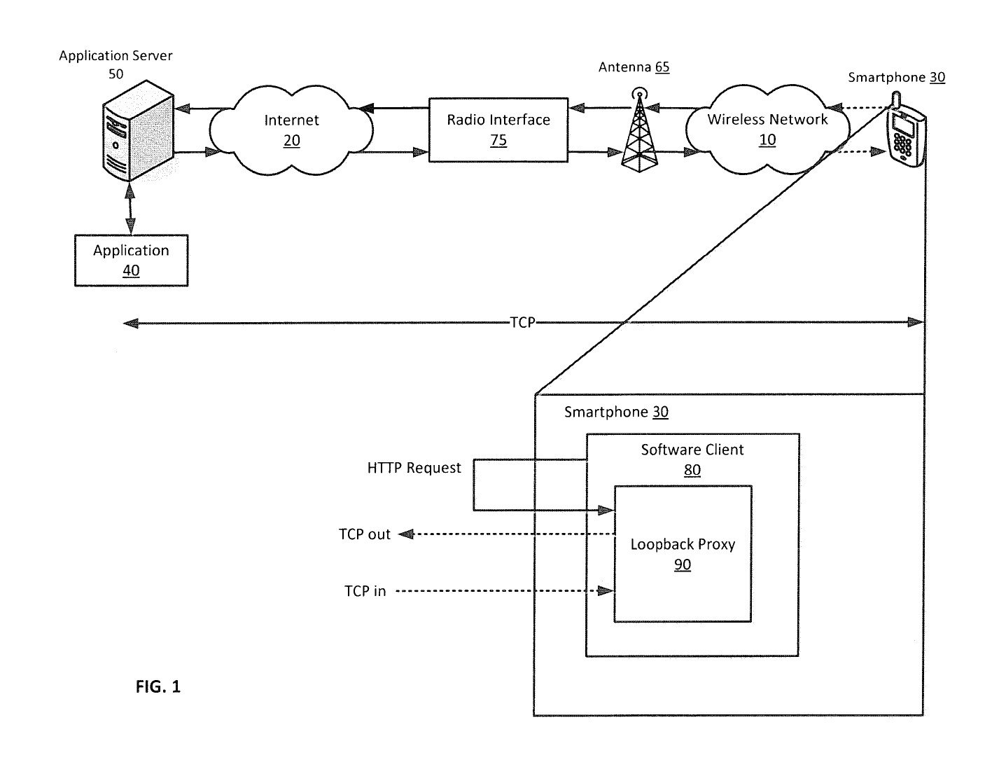

Referring now to FIG. 1, a wireless connection route between a mobile device 30, such as a smartphone, and the use of application 40 through the Internet 20 is illustrated. The mobile device 30 connects to a wireless network 10, which is linked to a base station or node B antenna 60 in the vicinity of the mobile device. The antenna 60 is controlled by a radio interface 75, such as Gateway General Serving Support Node (“GGSN”), Serving GPRS Support Node (“SGSN”), or Radio Network Controller (“RNC”). The radio interface 75 also provides access to a desired application 40 through the Internet 20. The application 40 is hosted on an application server 50. In a typical embodiment, the network protocols used for the transfer of packets in the system illustrated is TCP. The elements shown in FIG. 1 are illustrative only and not intended to limit this disclosure.

In one embodiment, mobile device 30 includes a software client 80 programmed and configured with a loopback proxy service 90 that re-directs network references back to the local host. The proxy 90 intercepts the HTTP requests from the mobile device 30, and monitors a fixed port on the mobile device to detect incoming TCP connections. The proxy service 90 then manages the connection process to fuse the streams from the local connection and the remote connection.

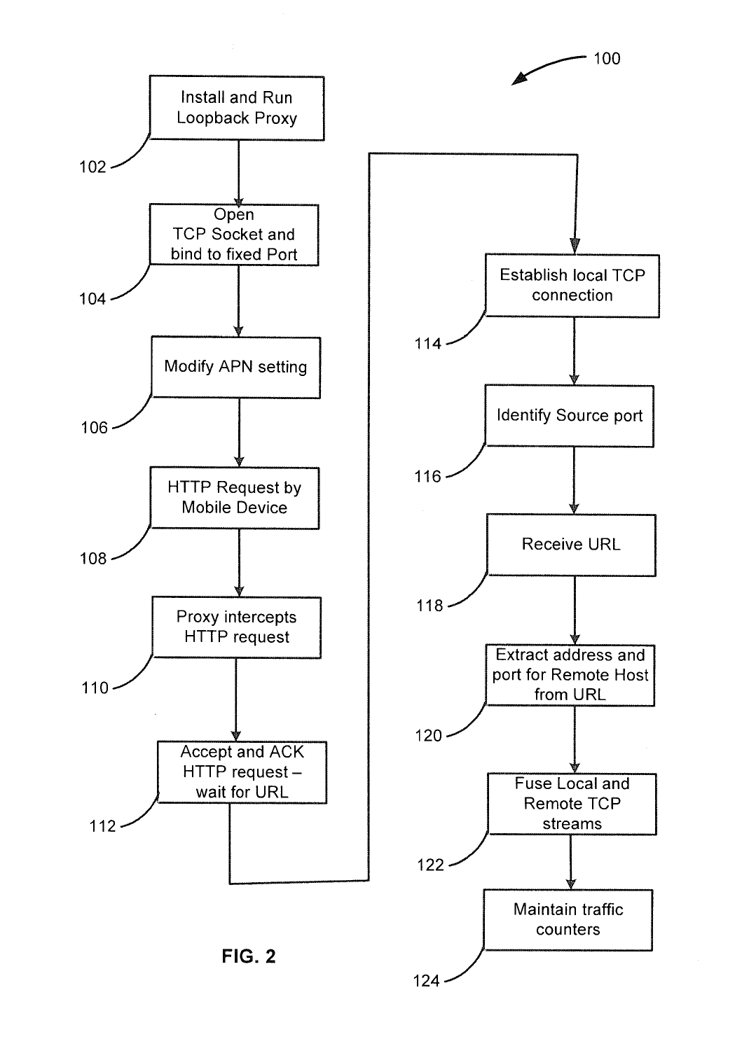

FIG. 2 illustrates a process 100 for using the loopback proxy 90 to manage HTTP requests from the mobile device 30. In step 102, the proxy 90 is installed as software on the mobile device and executed. In step 104, the proxy 90 opens a TCP socket on the mobile device 30 and binds it to a fixed port X on the “local host.” Of course, the local host is the mobile device 30 and the standard loopback IP address is 127.0.0.1. The fixed port X on the mobile device thus listens for incoming TCP connections. IP address 127.0.0.1 is a special purpose address reserved for use to access to the TCP/IP resources of a local computer, in this case the mobile device 30.

In step 106, a configuration setting of the mobile device 30, specifically the access point node (“APN”), is modified by the proxy 90 so that the proxy address points to the fixed port of the local host at 127.0.0.1:X. All other carrier settings are left unchanged. The APN setting is used to determine what type of network connection should be created. Thus, by specifying a fixed port of the local host, a local TCP connection will be created when the APN is called.

In step 108, the mobile device 30 makes an HTTP request. In step 110, the proxy 90 intercepts the HTTP request since the APN of the mobile device points to the loopback port. In step 112, the proxy 90 acknowledges and accepts the HTTP request and then waits for the URL request from the client. Once the HTTP request has been accepted, i.e., an acknowledgement of the request is received by the mobile device as described below, and a local TCP connection is established in step 114. The proxy 90 also maintains the connection context for the new connection and stores the local connection handle.

In step 116, the proxy 90 identifies the source port used by the application on the mobile device to connect to the proxy as well as the application process that opened the port. In step 118, the proxy receives the URL request from the mobile device. In step 120, extracts the address and port information for the remote host from the URL request. Note that SSL connections are also supported by implementing HTTP CONNNECT method handling.

Finally, in step 122, the proxy 90 fuses the local TCP connection stream with the remote TCP connection stream. Thus, any incoming data from the remote connection is sent to the local stream, and any incoming data from the local connection is sent to the remote stream.

Additionally, in step 124, the proxy maintains data traffic counters for the traffic generated by each session and groups them with the application name. The traffic statistics are preferably provided per application per interface. Further, a traffic control manager is configured to allow, block or alert to various conditions based upon data thresholds, application rules, location, visited carrier network, etc.

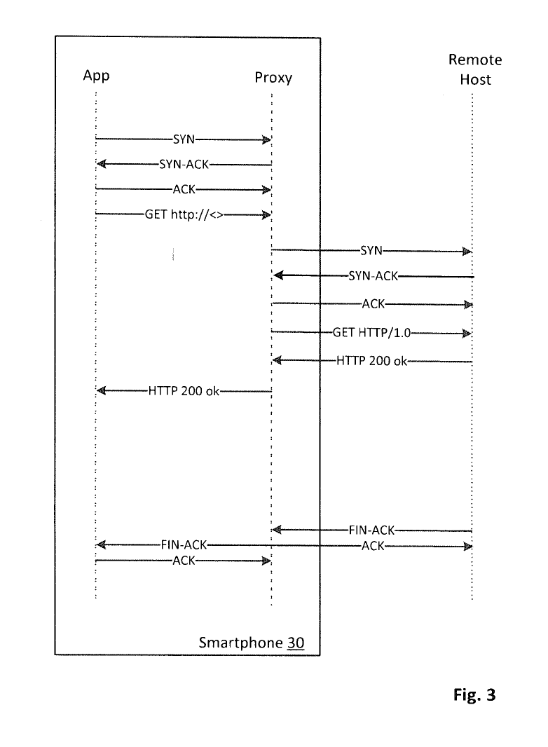

Referring now to FIG. 3, one embodiment of a TCP session using proxy 90 between the smartphone 30 and the remote host 50 is illustrated. The proxy 90 is configured to act as a transparent intermediary between the smartphone 30 and the remote host 50 and maintain a TCP data flow throughout the communication channel. As noted above, the proxy 90 opens a TCP socket, binds it to the loopback port 127.0.0.1:X of the smartphone, and listens for incoming TCP connections.

First, the smartphone is running an application that wants content from a remote host, so the application causes the smartphone to initiate a session by sending a TCP synchronize packet (“SYN”). The SYN packet is intended for the remote host through a network interfact, but because of the loopback port, the SYN packet is intercepted by the proxy, which then responds to the smartphone with a synchronize-acknowledgement packet (“SYN-ACK”) as if it was the remote host. The smartphone receives the SYN-ACK packet (thinking it is from the remote host) and thus sends an acknowledgement packet (“ACK”). Once the ACK packet is sent by the smartphone, it establishes a TCP connection. The smartphone then generates a GET HTTP request since it believes that a TCP socket is open and a TCP connection has been established.

The proxy extracts the remote host IP address and port designation from the HTTP request and then performs the TCP handshaking routine with the remote host by sending a SYN packet to the remote host. When the remote host receives the SYN packet, it responds with a SYN-ACK packet. When the proxy receives the SYN-ACK packet, it responds with an ACK packet. Thus, a TCP connection is established at the remote host.

The proxy fuses the local connection with the remote TCP connection and the session is established. Now, the proxy forwards the GET HTTP request to the remote host, and the remote host processes the HTTP request. If the remote host is successful in processing the request, it responds with HTTP status code 200, which is the standard response for a successful HTTP request. The proxy forwards the status code 200 to the application, and content is streamed between the remote host and the application in the smartphone.

Once the content has finished streaming, a finish packet (“FIN”) is sent by the application, intercepted by the proxy, and forwarded to the remote host. The remote host sends an acknowledgement of the finish packet (“FIN-ACK”), and the proxy responds with an acknowledgement (“ACK”), at which point the remote host closes its TCP connection. The proxy forwards the FIN-ACK to the application, which responds with its own ACK, and the TCP local connection is also closed.

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A method for managing TCP sessions in a mobile device, comprising:
providing a loopback proxy service on the mobile device, wherein the loopback proxy service intercepts and manages TCP sessions on the mobile device.

2. The method of claim 1, wherein the loopback proxy performs the steps of:
opening a TCP socket on the mobile device;
binding the TCP socket to a localhost address with a fixed port on the mobile device, modifying a configuration setting for a network identifier on the mobile device to point to the localhost address and fixed port;
monitoring the fixed port for incoming TCP connections;
receiving an HTTP request from the mobile device over a local TCP connection at the fixed port, the HTTP request seeking content from a remote host;
accepting the local TCP connection and acknowledging the HTTP request;
identifying a source port for the local TCP connection on the mobile device, and a destination address and a destination port for the remote host; and
combining streams from a remote TCP connection at the remote host with the local TCP connection.

3. The method of claim 2, wherein the localhost address is 127.0.0.1.

4. The method of claim 2, wherein the configuration setting is the access point name.

5. The method of claim 2, wherein the identifying step comprises:
extracting the destination address and the destination port for the remote host from a URL request made by the mobile device.

6. The method of claim 1, further comprising:
maintaining traffic counters for each TCP session with the loopback proxy service.

7. A non-transitory computer readable storage medium having executable instructions for managing TCP sessions in a mobile device, the instructions comprising:
providing a loopback proxy service on the mobile device, wherein the loopback proxy service intercepts and manages TCP sessions on the mobile device.

8. The non-transitory computer readable storage medium of claim 7, wherein the instructions for the loopback proxy further comprise:
opening a TCP socket on the mobile device;
binding the TCP socket to a localhost address with a fixed port on the mobile device,
modifying a configuration setting for a network identifier on the mobile device to point to the localhost address and fixed port;
monitoring the fixed port for incoming TCP connections;
receiving an HTTP request from the mobile device over a local TCP connection at the fixed port, the HTTP request seeking content from a remote host;
accepting the local TCP connection and acknowledging the HTTP request;
identifying a source port for the local TCP connection on the mobile device, and a destination address and a destination port for the remote host; and
combining streams from a remote TCP connection at the remote host with the local TCP connection.

9. The non-transitory computer readable storage medium of claim 8, wherein the instructions identify the localhost address as 127.0.0.1.

10. The non-transitory computer readable storage medium of claim 8, wherein the instructions identify the configuration setting as the access point name.

11. The non-transitory computer readable storage medium of claim 8, the instructions further comprising:
extracting the destination address and the destination port for the remote host from a URL request made by the mobile device.

12. The non-transitory computer readable storage medium of claim 8, the instructions further comprising:
maintaining traffic counters for each TCP session with the loopback proxy service.

13. A system for managing TCP sessions in a mobile device, comprising a loopback proxy service on the mobile device, wherein the loopback proxy service intercepts and manages TCP sessions on the mobile device.

14. The system of claim 13, wherein the loopback proxy service opens a TCP socket and binds it to a loopback port on the mobile device.

15. The system of claim 14, wherein the loopback port is a localhost address of 127.0.0.1.

16. The system of claim 14, wherein the configuration setting on the mobile device for network identifiers is modified to point to the loopback port.

17. The system of claim 16, wherein the loopback proxy service receives an HTTP request from the mobile device at the loopback port, establishes a local TCP connection and a remote TCP connection on behalf of the mobile device, and fuses the local TCP connection with the remote TCP connection.
